(19) United States
(12) Patent Application Publication
(10) Pub. No.: US 2021/0070505 A1
(43) Pub. Date: Mar. 11, 2021

(54) CONTAINER LID AND LINER, AND METHOD OF MANUFACTURING THE SAME

(71) Applicant: Koninklijke Douwe Egberts B.V., Utrecht (NL)

(72) Inventor: Stephanie Madeleine Henon, Utrecht (NL)

(21) Appl. No.: 16/965,946

(22) PCT Filed: Jan. 20, 2019
(86) PCT No.: PCT/EP2019/051375

§ 371 Date: Jul. 29, 2020

(30) Foreign Application Priority Data
Feb. 1, 2018 (GB) 1801645.1

(51) Int. Cl. B65D 41/04; B65D 51/16; B65D 53/04

(52) U.S. Cl. CPC B65D 41/045; B65D 53/04; B65D 51/1672

(57) ABSTRACT

This invention provides for a laminated liner (2) for a food or beverage ingredient container lid (416) comprising at least one lower layer (4) comprising one or more perforations (8) and at least one upper layer (6) comprising no perforations, and wherein the non-perforated upper layer or layers is/are releasably attached to the perforated lower layer or layers.

### TECHNICAL FIELD OF THE INVENTION

The present invention relates to a laminated liner for a food or beverage ingredient container lid. The present invention further relates to a food or beverage ingredient container lid; a method of assembling a liner for a food or beverage ingredient container lid; a method of manufacturing a food or beverage ingredient container lid and a method of assembling a food or beverage ingredient container.

### BACKGROUND TO THE INVENTION

It is well known to the skilled person in the art that roasted coffee may develop and release gases such as carbon monoxide, carbon dioxide and volatile aroma compounds (VOC) during and after the roasting process.

Those gases and volatile aroma compounds (VOC) can be released by the coffee also during storage.

In some cases, when coffee powder or beans are packed in a food container (such as for example a packet or a jar or any other type of packaging) valve means needs to be applied to such a packaging in order to allow internal pressure release during storage in order to avoid the seals or seams of the pack tearing and exposing the coffee (powder or beans) to air (more specifically oxygen), which reduces coffee shelf life and affects coffee quality and hygiene.

In other circumstances the internal pressure increase could even lead to rupture of the packaging during the opening action from the consumer, allowing the coffee to be ejected forcefully from the container (for example a coffee jar) and potentially falling on the consumer.

All these inconveniences could affect the consumers' experience of enjoying a cup of coffee for several reasons, among which include a) the deteriorated quality of the ingredient due to the ingredient (coffee) being exposed to the oxygen in the air and b) the fact that the ingredient might burst out of the container and stain the consumers' clothing.

It has been brought to the attention of the inventors that these inconveniences might occur also when a coffee packaging is manufactured at sea level (higher air pressure) and transported to high altitude (lower air pressure) markets in order to be sold.

In order to avoid this issue, in the prior art are known means, such as one-way valves which release internal pressure throughout storage of the container. An alternative solution is to manufacture coffee powder or beans under vacuum, and removing excess gases and volatile aromatic compounds (VOC) during packing.

All these known methods have the overall disadvantage of depriving the coffee of one of its most important sensorial qualities i.e. the aroma.

It would be therefore advantageous to provide a solution which would enable maintenance of the final aroma quality of food or beverage ingredient throughout storage and transport of the ingredient, whilst maintaining a hygienic seal of the container in which food or beverage ingredient is located.

It would be furthermore advantageous to provide a solution which would instantaneously release packaging internal pressure while opening the container, without spillage of any food or beverage ingredient.

It would also be advantageous to provide a food or beverage ingredient container lid which includes both the means to seal an opening of a container, and a means to enable venting of excess gas and/or VOCs upon opening, without spillage of any ingredient due to air pressure differences between the inside and the outside of the sealed container.

It is therefore an aim of embodiments of the invention to satisfy the highly-felt need of an optimised closure means such as a liner and lid assembly to overcome or mitigate at least one problem of the prior art whether disclosed herein or not.

### SUMMARY OF THE INVENTION

According to the first aspect of the invention there is provided a laminated liner for a food or beverage ingredient container lid, comprising at least one lower layer comprising one or more perforations and at least one upper layer comprising no perforations, and wherein the non-perforated upper layer or layers is/are releasably attached to the perforated lower layer or layers.

The term “lid” is synonymous with “closure” and “cap” and each term may be used interchangeably.

In a preferred embodiment, the laminated liner may comprise only one non-perforated upper layer.

In a further embodiment, the laminated liner may comprise at least two perforated lower layers and a non-perforated upper layer.

The or each perforation is preferably configured and/or sized to prevent egress of food or beverage whilst allowing air (or air pressure) to egress. In some embodiments there may be a single perforation, whilst in other embodiments there may be multiple perforations, such as between 2 and 25 perforations, for example, such as 2, 3, 4, 5, 6, 7, 8, 9, 10, 12, 15, 20 or 25.

In some embodiments, the laminated liner comprises multiple perforations arranged through the lower layer or the lower layers to create a pattern of perforations.

The diameter (or largest dimension) of the perforation, or total cumulative length of the diameters (or largest dimensions) of the perforations may be at least 0.01 mm, 0.02 mm, 0.05 mm, 0.1 mm, 0.2 mm, 0.3 mm, 0.4 mm, 0.5 mm, 0.6 mm, 0.7 mm, 0.8 mm or at least 0.9 mm, and/or may be no more than 1.5 mm. 1.4 mm, 1.3 mm, 1.2 mm, 1.1 mm or 1 mm. The total length of the diameter or diameters (or largest dimension) of the perforation and/or perforations may be in the range of 0.01 to 1 mm, preferably 0.5 mm. Thus, the cross-sectional area of the perforation or total cross-sectional area of all of the perforations may be at least 0.0008 mm², 0.01 mm², 0.05 mm², 0.08 mm² or at least 0.1 mm² and/or no more than 2 mm², 1.5 mm², 1.25 mm² or no more than 1 mm². In preferred embodiments the cross-sectional area of the perforation or perforations may be between approximately 0.008 mm² and 1 mm², or between 0.08 mm² and 0.8 mm².

In some embodiments, the non-perforated layer or layers is/are releasably connected to the perforated lower layer or layers, through an adhesive layer. The adhesive layer may be perforated and may be a lower layer of the liner, and in this embodiment the adhesive later is retained on the lower layer or layers when the upper layer or layers is/are detached. In an alternative embodiment the adhesive layer is an upper layer and is detached from the lower layer or layers when the upper layer or layers is/are detached.

Furthermore, the adhesive layer may be selected from a wax layer, a releasable adhesive layer or a combination thereof. The adhesive layer may comprise one or more adhesive materials selected from a cold seal adhesive, a heat seal adhesive, a lacquer, a wax, a polyolefin or any combination thereof.

In some embodiments, the uppermost layer is releasably attached to the adhesive layer. In other embodiments the lowermost upper layer is releasably attached to the adhesive layer, and thus all of the upper layers may be released when the lowermost upper layer detaches from the adhesive layer.

In other embodiments the adhesive layer may comprise a layer having a gripping surface, such as a textured surface, embossed surface or the like, for example.

In another embodiment the uppermost perforated layer and/or lowermost non-perforated layer may comprise gripping means per se, such as such as a textured surface, embossed surface or the like, for example, and no separate adhesive layer may be required. In embodiments having gripping means such as a textured surface, embossed surface or the like, both the uppermost perforated layer and lowermost non-perforated layer may comprise complementary gripping means, arranged in use to detach when a pulling force is applied thereto.

Preferably, the non-perforated layer or layers has/have the same diameter and/or dimensions as the perforated layer or layers.

In a preferred embodiment, the non-perforated layer or layers have the same shape as the perforated layer or layers.

The shape of the layers may comprise a shape selected from a disc, circle, oval, triangle, trapezium, rectangle, square, parallelogram, or pentagon, for example.

In a preferred embodiment, the diameter of the layers may be from 10 to 100 mm, preferably between 20 mm and 80 mm, or between 40 mm and 80 mm.

The perforation or perforations on the perforated layer or layers is/are preferably adapted such that in use each perforation is exposed to the atmosphere after detaching the non-perforated upper layer or layers from the lower layer or layers.

The perforation or perforations on the perforated layer or layers is/are arranged in use to open a fluid communication through the lower layer or layers after the upper layer or layers is/are detached.

One or more upper layers, and preferably the uppermost upper layer, may comprise at least one material selected from cardboard; cartonboard; paperboard; polymeric substrate (such as polyethylene or polyethylene terephthalate PET) and paper or a combination thereof, preferably having a thickness of at least 0.01 to 2 mm.

The liner may comprise at least two lower layers comprising a lowermost container opening sealing layer and an adhesive layer, and an upper layer comprising an uppermost container lid contact layer.

In a further preferred embodiment, the liner comprises four or more layers and each layer other than the uppermost layer is perforated. The four layers may comprise a lowermost container opening sealing layer, a metal layer, an adhesive layer and an uppermost food or beverage ingredient container lid contact layer.

The metal layer may comprise an aluminium layer or foil.

In some embodiments, at least one lower layer, preferably at least the lowermost layer (which may be the lowermost container opening sealing layer) may comprise material selected from polymer coated paper and/or polymer, and particularly glassine.

Although the laminated liner of the first aspect of the invention has been described as a liner for a container lid, it is apparent that the laminated liner can also be considered a laminated seal or cover for the opening or rim of a container to which a lid is attached, as part of the laminated liner is intended to be sealed to the opening or rim of a container. All features and embodiments of the first aspect of the invention may apply equally to this use. Thus, the first aspect of the invention can also be considered a seal or cover for the opening or rim of a container, comprising at least one lower layer comprising one or more perforations and at least one upper layer comprising no perforations, and wherein the non-perforated upper layer or layers is/are releasably attached to the perforated lower layer or layers.

According to a second aspect of the invention there is provided a food or beverage ingredient container lid having an inside and an outside surface and comprising a multi-layered laminated liner of the first aspect of the invention, wherein at least the uppermost layer of the liner is connected to the inside surface of the lid.

In a preferred embodiment, all of the non-perforated layer or layers on the inside surface of the lid is/are arranged to be retained, in use, on the inside surface of the lid after the perforated layer or layers is/are detached. In this embodiment the uppermost layer may be fixedly connected to the inside surface of the lid, and the remaining upper layers may be fixedly connected to the uppermost layer. In one embodiment, only the uppermost layer of the liner is non-perforated. In another embodiment more than one upper layer, including the uppermost layer, is non-perforated.

The lid may be a screw-cap lid, push-fit lid or a snap-on lid, for example.

According to a third aspect of the invention there is provided a method of assembling a liner for a food or beverage ingredient container lid comprising the steps of
a) providing a laminated liner comprising at least one lower layer and at least one upper layer, wherein the upper layer or layers is/are releasably connected to the lower layer or layers; and
b) making at least one perforation through the lower layer or layers of the laminated liner, whilst leaving at least one upper layer intact with no perforation, in order to obtain a partially perforated laminated liner.

In a preferred embodiment, the method may further comprise the step of shaping the liner perimeter between step a) and b) or simultaneously with step b).

The shaping step may comprise cutting the liner to form a perimeter shape corresponding to a food or beverage ingredient container lid interior surface perimeter.

In some embodiments, the liner may comprise at least two lower layers which are perforated in step b).

The liner may comprise at least two lower layers comprising a lowermost food or beverage ingredient container opening sealing layer and an adhesive layer, and an upper layer comprising an uppermost food or beverage ingredient container lid contact layer.

In a further preferred embodiment, the liner comprises four or more layers and each layer other than the uppermost layer is perforated in step b).

The four layers may comprise a lowermost container opening sealing layer, a metal layer, an adhesive layer and an uppermost food or beverage ingredient container lid contact layer.

As with the first aspect of the invention the method of the third aspect of the invention may also be considered a method for assembling a cover or seal for the opening or rim of a food or beverage container.

According to a fourth aspect of the invention there is provided a method of manufacturing a food or beverage ingredient container lid, comprising assembling a liner according to the method of the third aspect of the invention and further comprising a step c) of providing a food or beverage container lid having an inside surface and an outside surface and connecting the uppermost layer of the partially perforated liner to the inside of the food or beverage container lid.

Steps b) and c) may be performed simultaneously or consecutively.

According to a fifth aspect of the invention there is provided a method of assembling a food or beverage ingredient container comprising the steps of sealing a lowermost layer of the liner of the lid produced according to the method of the third aspect of the invention to an opening of a food or beverage ingredient container before, during or after step c) of the method of the fourth aspect of the invention.

Sealing of the lowermost layer to the opening may comprise applying adhesive to the lowermost layer to the opening. The adhesive may be a permanent adhesive. The opening may comprise a rim, and adhesive may be applied to the rim before adhering the lowermost layer to the adhesive on the rim. Alternatively, the lowermost layer may be provided with an adhesive in areas corresponding to the position of the rim, and the lowermost layer adhered to the rim. For example, if the rim of the opening is circular, then the rim and/or lowermost layer may comprise a circle of adhesive thereon.

The method may comprise at least partially filling the container with a food or beverage ingredient before connecting the lid to the beverage, and preferably before applying any adhesive to any rim or opening of the container. The food or beverage ingredient may comprise coffee, tea, creamer, milk powder, malted food or beverage powder, chocolate powder, cocoa powder, flavoured food or beverage powder or crystals, or the like.

According to a sixth aspect of the invention there is provided a food or beverage ingredient container comprising a lid of the second aspect of the invention connected thereto.

The container may comprise an opening rim to which is connected the lowermost perforated layer of the liner.

The lowermost layer of the liner may be permanently or removably connected to the rim.

In a preferred embodiment the container is a beverage ingredient container.

Preferably the beverage ingredient container is a coffee container.

The container may comprise a food or beverage ingredient, which may be a powder, granules or a fluid such as a liquid, paste or gel for example.

In preferred embodiments the beverage ingredient comprises a beverage powder or granules, and is preferably coffee, milk, a creamer or chocolate, more preferably coffee.

### DETAILED DESCRIPTION OF THE INVENTION

In order that the invention may be more clearly understood, embodiments thereof will now be described, by way of example only, with reference to the accompanying drawings of which:

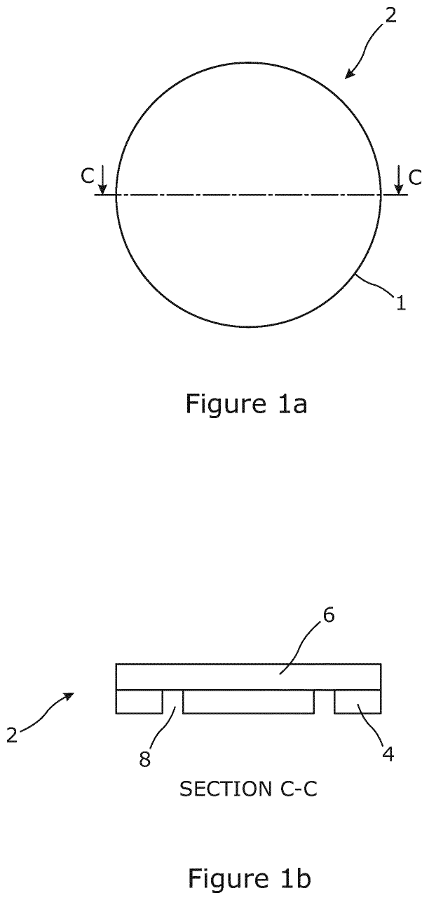

FIG. 1a illustrates a top-down view of a first embodiment of a laminated liner for a food or beverage ingredient container lid (or a laminated seal or cover for the opening or rim of a food or beverage container) according to the invention;

FIG. 1b illustrates a side cross sectional view along line C-C of a laminated liner of the first embodiment of FIG. 1a according to the invention;

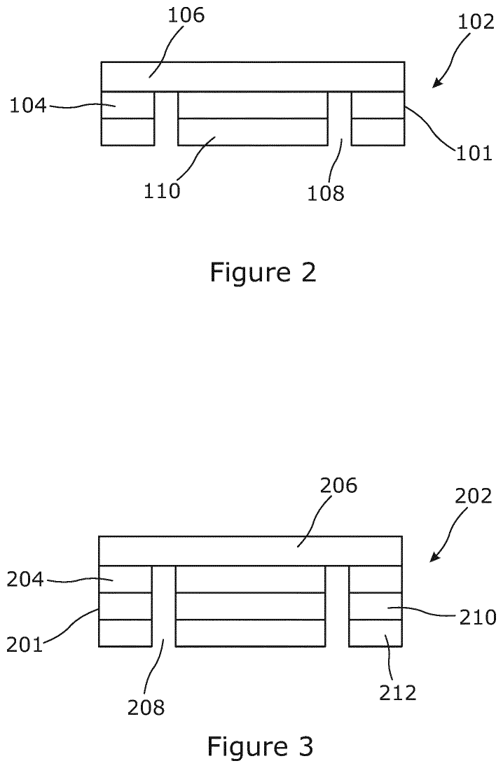

FIG. 2 illustrates a side cross sectional view along line C-C of a second embodiment of a laminated liner for a food or beverage ingredient container lid (or a laminated seal or cover for the opening or rim of a food or beverage container) according to the invention, having three layers;

FIG. 3 illustrates a side cross sectional view along line C-C of a third embodiment of a laminated liner for a food or beverage ingredient container lid (or a laminated seal or cover for the opening or rim of a food or beverage container) comprising three lower perforated layers and one single non-perforated upper layer, according to the invention;

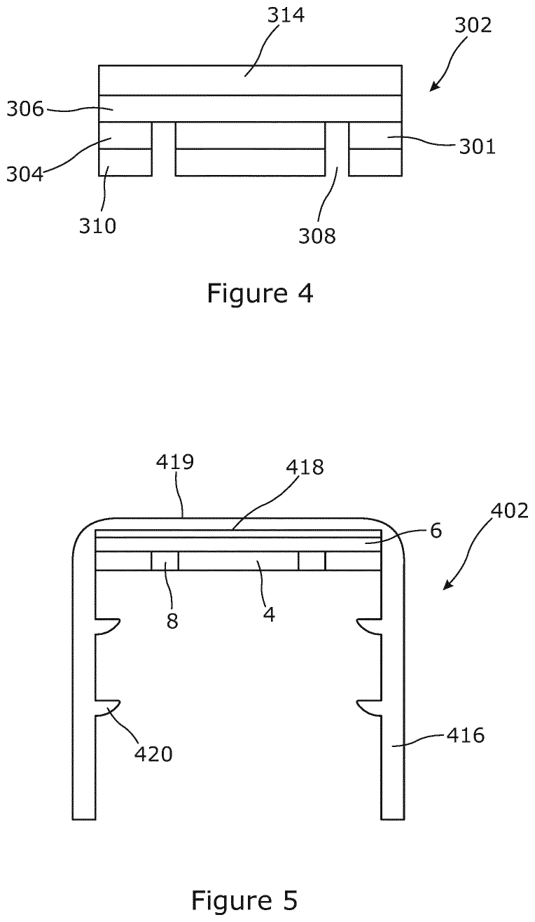

FIG. 4 illustrates a side cross sectional view along line C-C of an alternative four-layer laminated liner for a food or beverage ingredient container lid (or a laminated seal or cover for the opening or rim of a food or beverage container) to that shown in FIG. 3, comprising two lower perforated layers and two upper non-perforated layers, according to the invention;

FIG. 5 illustrates a side cross sectional view along line C-C of an assembly of a two-layer laminated liner of the invention, inserted into a food or beverage ingredient container lid according to the invention;

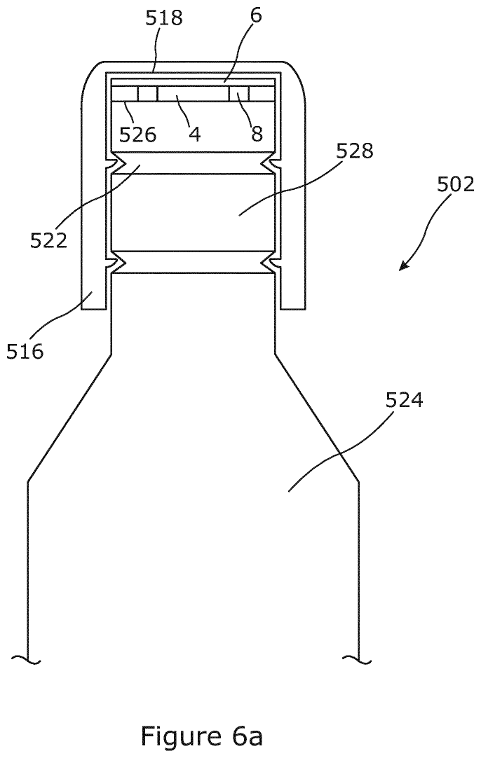

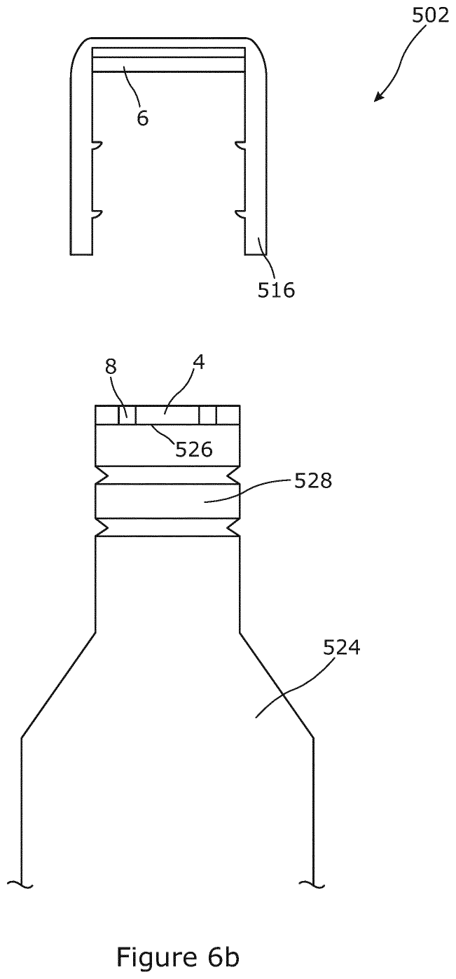

FIG. 6a illustrates a side cross sectional view along line C-C of a container of the invention comprising an assembly of a food or beverage ingredient container lid of the invention provided with a two-layers laminated liner of the invention, and a food or beverage ingredient container;

FIG. 6b illustrates a side cross sectional view along line C-C of the food or beverage ingredient container lid detached from a food or beverage ingredient container of FIG. 6a.

Referring to the following Figures like numbers represent like components.

Referring firstly to FIG. 1a and FIG. 1b an embodiment of a two-layer laminated liner (2) for a food or beverage ingredient container lid, according to the invention, is shown. In such embodiment the laminated liner (2) is provided by the combination of a lower, perforated layer (4) and an upper, non-perforated layer (6) in such a way that the lower surface of the non-perforated (6) layer detachably adheres to the upper surface of the perforated layer (4). The lower perforated layer (4) includes a number of perforations (8) extending therethrough. Both layers (4, 6) are aligned with each other so that the lower surface of the non-perforated layer (6), is configured on the upper surface of the perforated layer (4), and covers the perforations (8) of the perforated layer (4) and the external perimeters and shapes of (1) of the two layers (4, 6) match each other.

The two layers (4, 6) in this embodiment are maintained adjacent by the conformation, shape and/or structure of the abutting surfaces which comprise gripping means which may for example be textured and/or embossed areas of one or both layers (4,6), ensuring a stable engagement of the two layers (4,6) to each other.

In an alternative arrangement of the first embodiment (not shown), the two layers (4, 6) may be kept adjacent and aligned through an adhesive material (not shown) which may be applied to the abutting surfaces of one or both the adjacent layers (4, 6).

In a further arrangement, as alternative solution, the layers' (4,6) surfaces to be releasably connected may be made of and/or incorporate an adhesive or tacky material which makes the two surfaces releasably adhere to each other, keeping them connected until further forces are applied to them.

Further, in other arrangements, to ensure that the two layers stay in contact, a wax type material may be used as an alternative to or in combination with the adhesive material. In the arrangement of the first embodiment, the connection between the perforated layer (4) and the non-perforated layer is a releasable connection, i.e. the two layers (4,6) can be separated from each other to expose the perforations (8) through an action performed by the user which breaks this connection.

In the first embodiment, the perforated and non-perforated layers (4,6) have identical shapes and these may include a disc, circle, oval, triangle, trapezium, rectangle, square, rectangle, square, parallelogram, or pentagon shape. When the perforated and non-perforated layers (4,6) have a disc or circular shape, the largest dimension (diameter) may be identical and in the range of 10 mm and 100 mm. In a preferred arrangement of the first embodiment of the invention, the diameter can vary between 20 mm and 70 mm.

The perforated layer (4) of FIG. 1 may be in the form of an aluminium foil, while the non-perforated layer (6) may be in the form of a cardboard, cartonboard, paperboard, paper and/or a polymeric substrate such as polyethylene, expanded polyethylene foam or the like, and preferably having a thickness of between 0.01 to 2 mm. For manufacturing the non-perforated layer (6) any combination of the abovementioned materials can be taken into consideration.

In an alternative arrangement of the first embodiment of the invention the lower perforated layer (4) may include one single perforation or hole rather than a plurality of perforations or holes (8). In the embodiment shown for FIG. 1a and 1b, the multiple perforations (8) may be arranged into a pattern or arranged randomly through the entire surface of the perforated layer (4). The single perforation and/or the plurality of perforations (8) is/are adapted to extend the entire depth of the perforated layer in order to create a passageway through the perforated layer (4) itself.

In a preferred arrangement of the first embodiment of the invention, the total length of the diameter or diameters of the perforation and/or perforations (8) may be in the range between 0.1 and 1 mm, preferably between 0.2 and 0.7 mm and more preferably around 0.5 mm. The connection between the perforated layer (4) and non-perforated layer (6) is a releasable connection which ensures exposure of the perforations (8) to the atmosphere when a force is applied to the liner, such as pulling the upper non-perforated layer.

In the embodiment of FIG. 2, a three-layer laminated liner (102) according to the invention is represented.

In the embodiment of FIG. 2, the liner (102) comprises a lowermost lower perforated layer (110) and an uppermost lower perforated layer (104) which are connected to each other in such a way that their perimeters (101) match and are aligned one on top of the other. The lower surface of the uppermost perforated layer (104) is abutting/adjacent to the upper surface of the lowermost perforated layer (110). A plurality of perforations (108) goes all the way through the entire depth of the two perforated layers (104, 110).

A non-perforated layer (106) is connected to the uppermost perforated layer (104) in such a way that perforations (108) are obstructed and not exposed to the atmosphere. The same types of connections as described in the embodiment of FIG. 1, can be used to connect, attach, the two layers 104 and 106.

Further, shapes, dimensions and materials of the three layers 106, 104 and 110 correspond respectively to the shapes, dimensions and material described in the arrangements of FIG. 1 in relation to the two layers (6) and (4).

In a preferred arrangement of the first embodiment of FIG. 2, the lowermost perforated layer (110) is in the form a glassine, i.e. a smooth and thin paper layer highly resistant to the passage of air/moisture and grease. Alternative materials may be used to manufacture the lowermost perforated layer (110) include polyethylene, polyethylene terephthalate and metalised foil and substrates, for example.

In an alternative arrangement of the embodiment of FIG. 2 (not shown) a single perforation may be provided through the depth of the two lower layers 104 and 110. As per the arrangement shown in FIG. 2 this perforation is obstructed by the uppermost non-perforated layer (106) when the non-perforated layer is connected to the uppermost lower, perforated layer (104).

FIG. 3 shows a third embodiment of a liner (202) of the invention, comprising a four-layer laminated liner (202) according to the invention.

In a preferred arrangement, the liner (202) comprises three lower layers (204, 210 and 212) which are in the form respectively of a lowermost glassine layer (212), an aluminium middle layer (210), and an uppermost adhesive layer (204) in the form of a wax layer and/or alternatively a lacquer and/or polyolefins and/or a combination of these materials.

A plurality of perforations (208) extend though the three lower layers (204, 210, 214) but an alternative arrangement may include a single perforation. The perforations (208) are aligned to each other along the depth of the three layers (204, 210 and 212) in order to create a continuous and uninterrupted passageway through the depth of the three layers (204, 210 and 212) when connected to each other.

The perforations (208) are closed by an uppermost (upper) non-perforated layer (206) which acts as obstacle to obstruct these passages (208) preventing them to be exposed to the atmosphere while the upper non-perforated layer (206) is connected. Furthermore, the external perimeters (201) of the three perforated layers (204, 210 and 212) and the non-perforated layer (206) match and are aligned one on top to the other. The non-perforated layer (206) is connected to the uppermost perforated layer (204).

In a preferred arrangement, the uppermost non-perforated layer (206) is releasably connected to the uppermost perforated adhesive layer (204) in such a way that the two layers (204, 206) may be detached by an external action or force which breaks said connection, exposing the perforations (208) to the atmosphere opening the passageway through these perforations (208).

The intrinsic characteristic of the adhesive material of layer (204) ensures a connection not only between the non-perforated layer (206) and the uppermost perforated adhesive layer (204) but also between the adhesive perforated layer (204) and the aluminium middle perforated layer (210).

In a further arrangement, the lowermost perforated layer (212) is kept adjacent and aligned to the upper perforated layer (210) through an adhesive material (not shown) which may be applied to the abutting surfaces of one or both the adjacent layers (210, 212), or through heat lamination.

In some arrangements, the two perforated layers (210, 212) may be maintained adjacent by the conformation (shape and/or structure) of the abutting surfaces which may for example be textured (not shown) and/or embossed (not shown) ensuring a stable engagement of the two layers (210, 212) one to the other.

Further, in other arrangements, to ensure that the two layers (210, 212) stay in contact, a wax type material may be used as an alternative to, or in combination with, other adhesive materials.

In some further arrangements, the perforated and non-perforated layers (204, 210, 212, 206) may have identical shapes and these may include a disc, circle, oval, triangle, trapezium, rectangle, square, rectangle, square, parallelogram, or pentagon shape, for example. When the perforated and non-perforated layers (204, 210, 2012, 206) have a disc or circular shape, their diameter of the layers may be in the range of 10 mm and 100 mm.

In a preferred arrangement of the first embodiment of the invention, the diameter length can vary between 20 mm and 80 mm, such as between 50 mm and 80 mm and especially 53 mm or 70 mm.

The non-perforated layer (206) may be in the form of a cardboard, cartonboard, paperboard and/or paper having a thickness of at least 0.01 to 2 mm. For manufacturing the non-perforated layer (206) any combination of the abovementioned materials can be taken into consideration.

Referring to FIG. 4, an embodiment of a four-layer laminated liner (402) for a food or beverage ingredient container lid, according to the invention, is shown.

The laminated liner (302) presents two lower perforated layers (304, 310) and two upper non-perforated layers (306, 314).

In a preferred arrangement of the embodiment of FIG. 4, the liner (302) comprises two lower perforated layers (304, 310) and two upper non-perforated layers (306, 314). The uppermost perforated layer (304) and the lowermost non-perforated layer (306) are releasably connected, and attached to each other in such a way that their perimeters (301) match and are aligned one on top to the other. The lower layers (304, 310) include a plurality of perforations (308) extending therethrough. The lower surface (not shown) of the uppermost perforated layer (304) is abutting/adjacent to the upper surface (not shown) of the lowermost non-perforated layer (306) in such a way that the lowermost non-perforated layer (306) obstructs the perforations (308), preventing them to be exposed to the atmosphere.

The plurality of perforations (308) extend through the entire depth of the two perforated layers (304, 310).

The same types of connections as described in the embodiment of FIG. 1 and FIG. 3 can be considered to connect the two non-perforated layers 304 and 306 and/or the two perforated layers 306 and 314, i.e. through an adhesive material and/or textured or embossed conformation of the surfaces to be connected.

Furthermore, the shapes, dimensions and materials of the two layers 304 and 310 respectively correspond to shapes, dimensions and material described in the arrangements of FIG. 2 in relation to the two perforated layers 104 and 110.

The two upper non-perforated layers (306, 314) are in the form of a cardboard, cartonboard, paperboard and/or paper having a thickness of at least 0.01 to 2 mm or a combination thereof. The two upper layers (306, 314) may be kept adjacent through the abovementioned ways of connection, for example through textured or embossed conformation of the surfaces to be connected or using an adhesive material applied to one or both the two surfaces which need to be attached to each other.

FIG. 5 shows an embodiment of the two-layer laminated liner (2) as described above in relation to FIGS. 1 and 2, inserted in a food or beverage ingredient container lid (416), to provide a food or beverage ingredient container lid assembly (402) according to the invention. The lid (416) includes an outer surface (419) and an inner surface (418), as well as a screw thread (420) arranged in use to match a corresponding screw thread of a food or beverage ingredient container.

In a preferred arrangement, the two-layer laminated liner (2) is inserted into the interior surface of the lid which may be in the form a standard closure as a screw cap for sealing the food or beverage ingredient container (for example a coffee powder jar). Further closures can be considered for this purpose, for example friction fit closures and/or snap on caps.

The liner 2 adheres by friction fit of the upper layer (6) of the liner (2) to the interior surface of the lid (416), fitting firmly into the space within the upper interior surface (418) of the lid (416) and the ridge of its screw thread (420).

According to this embodiment of the invention, the assembly (402) of the lid (416) and the laminated liner (2) of FIG. 5 may be screwed onto the threaded neck of an ingredient container, as shown in an embodiment of a food or beverage container and lid assembly (502) in FIG. 6a.

The embodiment of the container and lid assembly (502) of FIG. 6a is the result of the assembly a lid (516), which is identical to the lid (416) of FIG. 5, screwed onto the threaded neck (522) of an ingredient container (524). FIGS. 6a and 6b shows the use of the liner (2) of FIG. 1b and the lid assembly (502) on a beverage or food ingredient container (524). All the liners described in FIGS. 1a, 1b, 2, 3, 4, 5 can be connected the interior surface (518) of the lid (516) to seal the ingredient container (524), which has an opening in the form of a neck (528) having an upper rim (526).

In use, the lower perforated layer (4) of the liner (2) within the lid (516) is sealed to the upper rim (526) of the ingredient container neck (528) by a wet glue process (not shown), i.e. applying wet glue to the rim (526) and sealing/pressing the lid (516) including the laminated liner (2) onto the glued rim (526). In this way the underside of the lower perforated layer (4) of the liner (2) adheres to the rim (526) to secure the liner (2) across the neck (528). This ensures hygiene and shelf life of the food or beverage ingredient inside the container (524). Thus, the liner (2) can also be considered a seal or cover for the rim (526) or opening of a food or beverage ingredient container (524).

In another preferred embodiment, the four-layer laminated liner (202) of FIG. 3 can be applied to the interior surface (518) of the lid (524) of FIG. 6a.

FIG. 6b represents the configuration of the liner after removal of the lid (516) from the container (524) shown in FIG. 6a.

As the lid is unscrewed, the join between the uppermost non-perforated layer (6) and non-perforated layer (6) is ruptured and the non-perforated layer (6) is retained in the lid (516) while and the perforated layer (4) remains sealed on the upper rim (526) of the ingredient container neck (528). Once the releasable connection between the non-perforated layer (6) and the perforated layer (4) is broken, the perforations (8) are exposed to the atmosphere, allowing fluid communication between the inside of the container (518) and the atmosphere surrounding the container (518) itself. In this way, the perforations allow a fluid communication between the inside of the container to the external environment which in turn allows the any pressure build-up within the container (524) to release, together with any ingredient aroma, whilst the ingredient is fully retained by the remaining parts of the liner (2) sealed to the neck (528). In this way, the ingredient cannot burst out of the container (524) upon the release of pressure through the perforations, as the perforations are not large enough for the ingredient to fit through. In this preferred embodiment, the perforated layer (4) of the original two-layer laminated liner remains sealed onto the upper rim (526) of the container's neck (528) after the lid (516) is removed, bringing the upper non-perforated layer (6) with it.

In an alternative embodiment, the liner into the lid can be replaced with liner of FIGS. 2 to 4.

Manufacture of the Liners, Lids and Containers of the Invention

### Example 1

An embodiment of a method of production of a multi-layer laminated liner (2, 102, 202, 302) described for FIGS. 1-6 is described hereafter. The method includes seven stages, as follows:

Stage 1—the upper and lower layer or layers of the liner are laminated together;

Stage 2—the laminated layers are rolled into a reel and sent to a drive roller station;

Stage 3—at the drive roller station the laminated liner is flattened and centred in order to be ready for a pre-cutting and perforation station;

Stage 4—liner is pre-cut in discs (or other relevant shapes) which are retained on the reel sheet and simultaneously perforated leaving the at least one upper layer and/or layers intact then the liner is sent to a liner insertion station;

Stage 5—at the liner insertion station a pre-cut disc (or other relevant shape) is punched away from the reel sheet to be immediately inserted into the interior surface of a food or beverage container lid in one single step then the lids are sent to the control station while the reel sheet skeleton resulting from taking off the discs is disposed of;

Stage 6—each lid is checked through a control means (visual for example i.e. a camera, but any suitable control means may be used) to detect the presence of the liner in the lids. The lids which pass the control are then sent to the packaging station;

Stage 7—those lids are applied to containers filled with food ingredient in order to be sealed. The rim of the opening of the container is provided with an adhesive, which permanently seals the lower most layer of the liner to the rim, as the lids are attached to the container.

### Example 2

An alternative embodiment of a method of the production of a multi-layer laminated liner (2, 102, 202, 302) described for FIGS. 1-6. The method includes seven stages as follows:

Stage 1—upper and lower layer or layers of the liner are laminated;

Stage 2—the laminated layers are rolled into a reel and sent to a drive roller station;

Stage 3—at the drive roller station the laminated liner is flattened and centred in order to be ready for a cutting station;

Stage 4—the liner is cut in discs (or other relevant shapes) which separated from the reel sheet skeleton which is disposed then the discs are sent to a liner insertion station;

Stage 5—at the liner insertion station the discs are punched into the interior surface of a food and beverage ingredient container and perforated simultaneously, in one single step. The lids are sent to a control station;

Stage 6—each lid is checked through a control means (visual for example i.e. a camera, but any suitable control means may be used) to detect the presence of the liner into the lids. The lids which pass the control are then sent to the packaging station;

Stage 7—those lids are applied to containers filled with food and/or beverage ingredient in order to be sealed.

The above embodiments are described by way of example only. Many variations are possible without departing from the scope of the invention as defined in the appended claims.

1: A laminated liner for a food or beverage ingredient container lid comprising at least one perforated lower layer comprising one or more perforations and at least one non-perforated upper layer comprising no perforations, and wherein the non-perforated upper layer or layers is/are releasably attached to the perforated lower layer or layers.

2: A laminated liner as claimed in claim 1 wherein the liner comprises only one non-perforated upper layer.

3: A laminated liner as claimed in claim 1 wherein the liner comprises at least two perforated lower layers and a non-perforated upper layer.

4: A laminated liner as claimed in claim 1 comprising multiple perforations.

5: (canceled)

6: A laminated liner as claimed in claim 1 wherein the total length of the diameter or diameters (or largest dimension) of the perforation or the perforations is in the range of 0.01 to 1 mm.

7: A laminated liner as claimed in claim 1 wherein the non-perforated layer or layers is/are releasably connected to the perforated layer or layers, by way of an adhesive layer.

8: (canceled)

9: A laminated liner as claimed in claim 1 wherein the non-perforated layer or layers has/have the same diameter and/or dimensions as the perforated layer or layers.

10-12: (canceled)

13: A laminated liner as claimed in claim 1 wherein the perforation or perforations of the perforated layer or layers is/are arranged such that in use each perforation is exposed to the atmosphere after detaching the non-perforated upper layer or layers from the lower layer or layers.

14: A laminated liner according to claim 13 wherein the perforation or perforations on the perforated layer or layers is/are arranged in use to open a fluid communication through the lower layer or layers after the upper layer or layers is/are detached.

15: A laminated liner as claimed in claim 1 wherein the perforated layer or an uppermost one of the perforated layers in use becomes an uppermost layer of the liner after detaching the non-perforated layer or layers.

16: A food or beverage ingredient container lid having an inside and an outside surface and comprising a multi-layered laminated liner according to claim 1 wherein an uppermost layer of the liner is connected to the inside surface of the lid.

17: A food or beverage ingredient container lid according to claim 16 wherein the non-perforated layer or layers on the inside surface of the lid is/are fixedly retained on the inside surface of the lid after the layer or layers is/are detached.

18: A food or beverage ingredient container lid as claimed in claim 16 wherein only the uppermost layer of the liner is non-perforated.

19: A method of assembling a liner for a food or beverage ingredient container lid comprising the steps of
a) providing a laminated liner comprising at least one lower layer and at least one upper layer, wherein the upper layer or layers is/are releasably connected to the lower layer or layers; and
b) making at least one perforation through the lower layer or layers of the laminated liner, whilst leaving at least one upper layer intact with no perforation, in order to obtain a partially perforated laminated liner.

20: A method according to claim 19 further comprising a step of shaping a liner perimeter between step a) and b) or simultaneously with step b).

21: A method according to claim 19 wherein the shaping step comprises cutting the liner to form a perimeter shape corresponding to a food or beverage ingredient container lid interior surface perimeter.

22: A method according to claim 19 wherein the liner comprises at least two lower layers which are perforated in step b).

23: A method according to claim 22, wherein the liner comprises at least two lower layers comprising a lowermost container opening sealing layer and an adhesive layer, and an upper layer comprising an uppermost container lid contact layer.

24: A method according to claim 22 wherein the liner comprises four or more layers and each layer other than an uppermost one of the layers is perforated in step b).

25: A method according to claim 24 wherein the four layers comprise a lowermost container opening sealing layer, a metal layer, an adhesive layer and an uppermost container lid contact layer.

26-29: (canceled)

30: A method of manufacturing a food or beverage ingredient container lid comprising performing the method of claim 19 and further comprising:
step c) providing a food or beverage container lid having an inside surface and an outside surface and connecting the uppermost layer of the partially perforated liner to the inside of the food or beverage container lid;
and wherein steps b) and c) are performed simultaneously or consecutively.

31: A method of assembling a food or beverage ingredient container comprising the steps of sealing a lowermost layer of the liner produced in claim 19 to an opening of a food or beverage ingredient container before, during or after a step of providing a food or beverage container lid having an inside surface and an outside surface and connecting the uppermost layer of the partially perforated liner to the inside of the food or beverage container lid.
